(19) United States
(12) Patent Application Publication
(10) Pub. No.: US 2015/0152869 A1
(43) Pub. Date: Jun. 4, 2015

(54) GRINDER PUMP

(71) Applicants: Guenter STRELOW, Bochum (DE); Roland Stracke, Unna (DE); Andreas Zeiss, Tauperlitz (DE); Viktor Warkentin, Dortmund (DE)

(72) Inventors: Guenter STRELOW, Bochum (DE); Roland Stracke, Unna (DE); Andreas Zeiss, Tauperlitz (DE); Viktor Warkentin, Dortmund (DE)

(21) Appl. No.: 14/165,805

(22) Filed: Jan. 28, 2014

(30) Foreign Application Priority Data
Nov. 29, 2013 (DE) 202013009716.7

(51) Int. Cl. F04D 7/04; B02C 18/00

(52) U.S. Cl. CPC F04D 7/045; B02C 18/0092

(57) ABSTRACT

A grinder pump has a housing having a bottom wall formed with an intake port, a drive shaft rotatable in the housing about an axis and projecting axially through the bottom wall, and a pump in the housing having a rotor connected to the shaft and operable to draw liquids and comminuted solids in through the port. A cutter head outside the housing at the bottom wall carries a blade juxtaposed with the bottom wall. The cutter head is fixed on and rotatable with the shaft for comminuting solids drawn into the intake port. An annular shield wall projects axially from the bottom wall around the cutter head and is formed with at least one axially projecting bump forming a valley constituting an intake opening through which liquid and solids can be drawn to the intake port by the pump.

### FIELD OF THE INVENTION

The present invention relates to a pump. More particularly this invention concerns a vertical-axis macerating or grinder pump.

### BACKGROUND OF THE INVENTION

A typical grinder pump has a cutting head mounted on the lower end of a vertical pump shaft that carries the motor pump. A lower end of the shaft carries a cutting head that rotates across a pump intake opening formed in a bottom wall of the housing. An annular wall projects axially downward around the cutting head and protects the cutting mechanism.

Such a grinder pump is from U.S. Pat. No. 3,938,744. It has a pump formed by an eccentric rotor screw and a cutting head carried on the lower end of the pump shaft. Here, the cutting head is surrounded by a tubularly cylindrical wall of uniform height that protects the cutting head and projects downward past it. With such a pump, it has been shown that although the cutting mechanism is protected from mechanical damage, flexible solids that are drawn in, such as cleaning cloths and rags, are still not sufficiently cut up and clog the pump.

### OBJECTS OF THE INVENTION

It is therefore an object of the present invention to provide an improved grinder pump.

Another object is the provision of such an improved grinder pump that overcomes the above-given disadvantages, in particular that comminutes flexible solids sufficiently so they do not clog the pump.

### SUMMARY OF THE INVENTION

A grinder pump has according to the invention a housing having a bottom wall formed with an intake port, a drive shaft rotatable in the housing about an axis and projecting axially through the bottom wall, and a pump in the housing having a rotor connected to the shaft and operable to draw liquids and comminuted solids in through the port. A cutter head outside the housing at the bottom wall carries a blade juxtaposed with the bottom wall. The cutter head is fixed on and rotatable with the shaft for comminuting solids drawn into the intake port. An annular shield wall projects axially from the bottom wall around the cutter head and is formed with at least one axially projecting bump forming a valley constituting an intake opening through which liquid and solids can be drawn to the intake port by the pump.

Normally there are at least three angularly spaced such bumps forming at least three respective valleys that are open axially outward away from the bottom wall.

Such a shield wall having a varying height, with one, two or more bumps that project downward, sufficiently protects the cutting mechanism from mechanical damage and furthermore significantly improves the cutting action of the cutting mechanism. Flexible solids, such as cleaning cloths and rags, are put into vibration by the flows produced by the shield wall, and thereby delayed in surges, so that slowed-down, controlled guidance to the cutting head takes place. Furthermore, the bumps ensure that the motor pump can no longer be set up vertically. A pump that can be set up vertically can easily be knocked over and thereby damaged.

An optimal behavior of the in-flow and further prevention of a vertical setup is also achieved in that the bumps have different heights relative to one another. For this purpose, it is also proposed that the bumps are distributed asymmetrically over the circumference of the lower edge of the shield wall, in such a manner that fewer or no bumps are provided on one half of the circumference than on the other half.

A particularly advantageous embodiment of the shield wall is achieved if the lower edge of the shield wall has the shape of a wave-shaped constant curve having one or two wing-like bumps that project downward. Preferably, it is proposed that the shield wall has a height in the region of the lowest point of the valley, which amounts to 1/20 to 1/2 of the height of the bumps. Alternatively, the lowest point of the valley can lie at the level of the lower face of the cutting plate that has the pump intake openings. Here, the two bumps should lie diametrically opposite one another.

Preferably, it is proposed that the bump(s) is/are V-shaped, U-shaped, or W-shaped. Instead, the bump can be formed by a slant of the lower edge of the shield wall.

Preferably, the cutting head has two diametrally opposite arms that slide closely over the cutting edges of two diametrally opposite the pump intake openings with their cutting edges. Secure conveying of solids is achieved if the pump is an eccentric screw pump whose rotor is between the cutting head and the drive motor.

### BRIEF DESCRIPTION OF THE DRAWING

The above and other objects, features, and advantages will become more readily apparent from the following description, reference being made to the accompanying drawing in which:

FIG. 1 is a perspective view from below;

FIG. 2 is a perspective view from above;

FIG. 3 is a larger-scale side view of the lower end of the pump;

FIG. 4 is a vertical section through the lower end of the pump;

FIG. 5 is a view like FIG. 1 of a pump with a pair of W-shaped bumps;

FIG. 6 is a view like FIG. 1 of a pump with a single bump; and

FIG. 7 is a view like FIG. 1 of a pump with two bump.

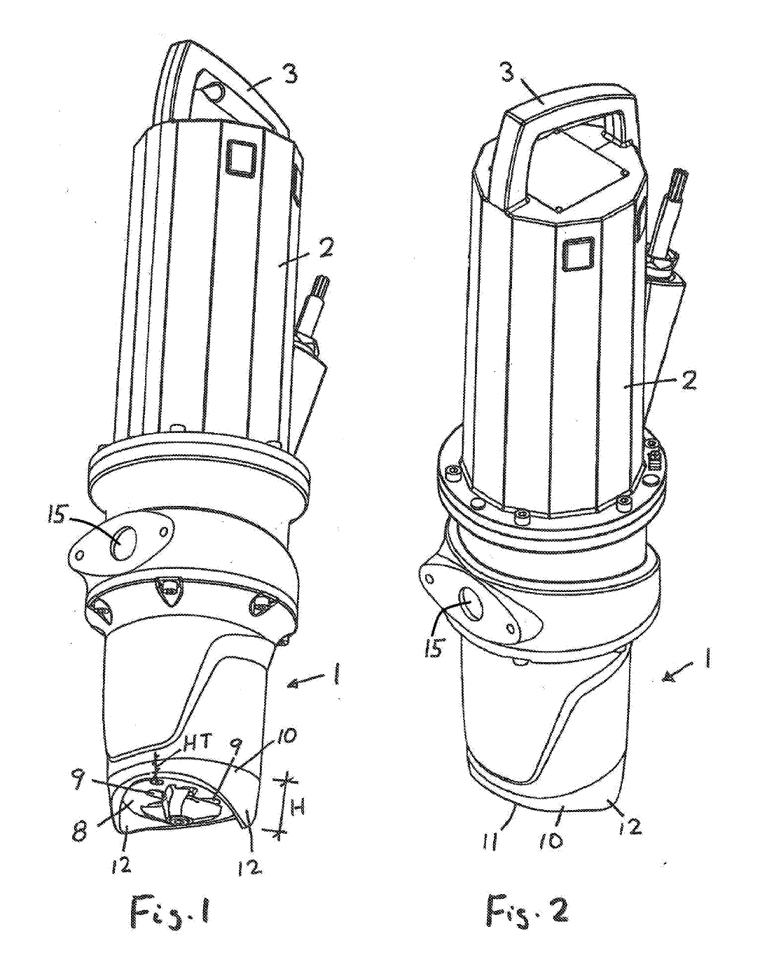

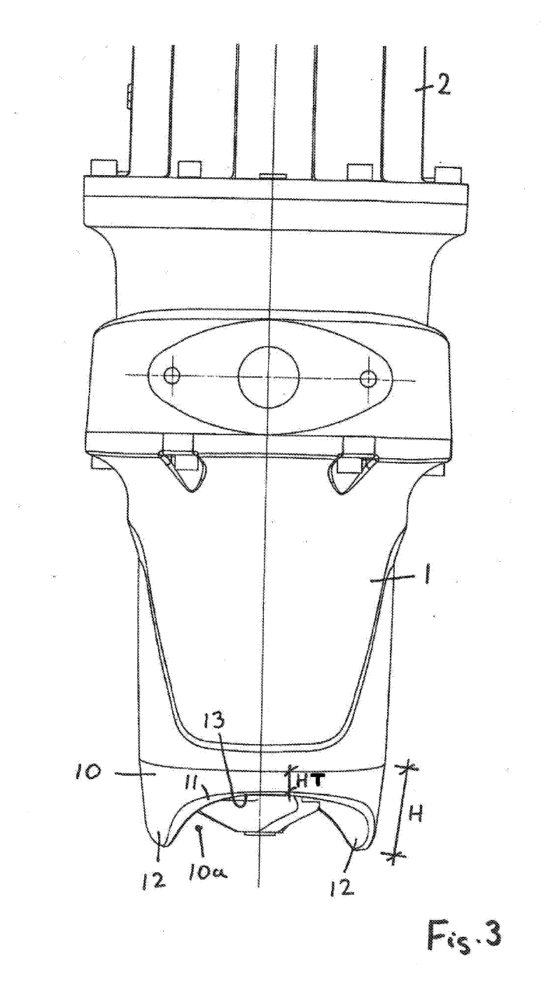

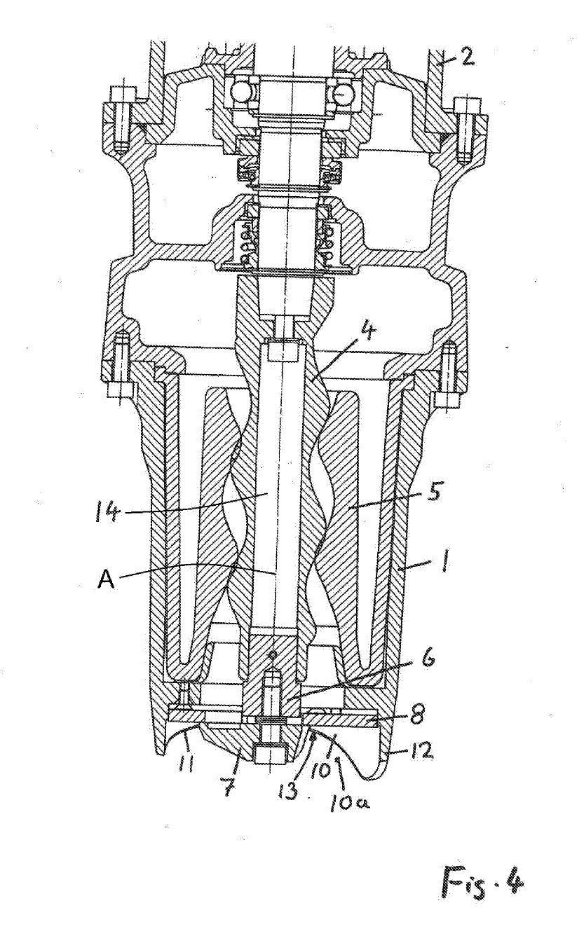

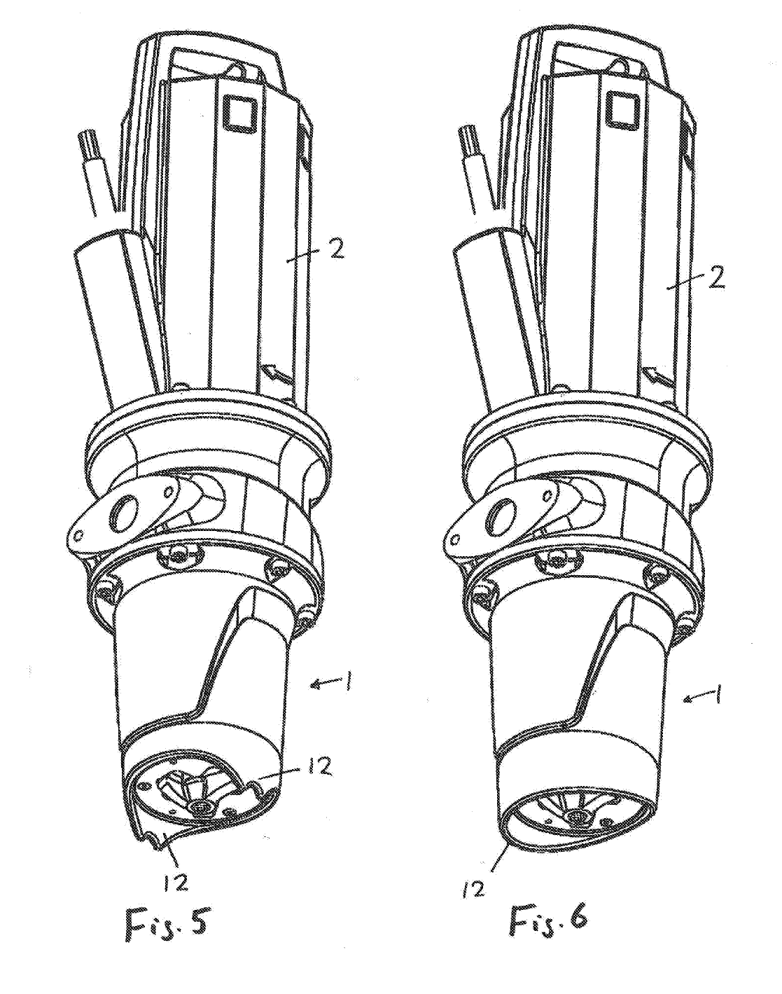

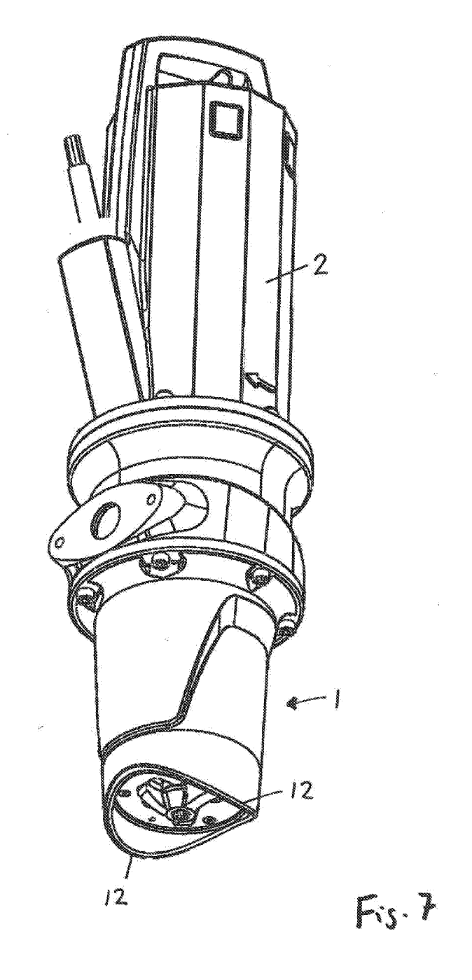

### SPECIFIC DESCRIPTION OF THE INVENTION

As seen in FIG. 1 a pump has a pump housing 1 on top of which a motor housing 2 is coaxially flanged. A handle 3 is attached at the upper end of the motor housing 2 so the pump can be easily carried and handled.

The pump has a rotor 4 in the form of an eccentric screw, which is coaxially attached at the lower end of a motor shaft 14 (FIG. 4) centered on a vertical axis A and lies, with its helicoidal outside surface in a tubular stator 5 whose inner surface has in its upper region a generally complementary helicoidal shape. The lower end of the pump rotor 4 is fixed to a coaxial shaft 6 of a cutting head 7. The shaft 6 passes through a blade plate 8 forming a bottom wall of the housing 2 and formed with intake ports 9 having sharp blade-like edges.

Thus rotation of the shaft 14 will operate the pump formed by the rotor 4 and stator 5 and will also rotate the two-bladed cutting head 7. The pump 4, 5 will draw liquid (and comminuted solids as described below) into the ports 9 and expel them through a lateral output 15 above the rotor 4 and stator 5. The cutting head 7 has two blades that slide over the planar lower face of the plate 8 and forces material to be ground against the edges of the ports 9 so as to comminute this material. The rotation speed of the head 7 is great compared to the speed at which solids are aspirated into the ports 7, so these solids are chopped into small pieces that the pump 4, 5 can easily handle.

The cutting head 7 is coaxially surrounded by a basically circular annular shield wall or collar 10 that forms a downward extension of the pump housing 1 and protects the cutting head 7 from mechanical damage. In prior-art grinder pumps, the shield wall 10 has the same axial height H all around. In the pump according to the invention however, the height H of the shield wall 10 varies angularly and smoothly around its circumference. Here, the shield wall 10 forms one, two, or more bumps 12 or feet having the height H and that project downward beyond the cutting head 7 with their downwardly directed apices. The lower edge 11 of the shield wall 10 is a wave-shaped curve, preferably having up to four wing-like bumps 12 that project downward. The bumps 12 have different axial heights H. This ensures that the pump does not stand perfectly perpendicular to a planar surface it is set on. Furthermore, for this purpose, the bumps 12 are spaced asymmetrically or nonuniformly around the circumference of the lower edge of the shield wall 10, such on one half of the wall 10 there are fewer (or no) bumps 12 than on the other half.

Valleys 13 are formed between the bumps 12 that form openings 10a that permit lateral or radially inward intake of the dirty household waste water with its solids (also including cleaning cloths and rags, among other things). Thus these solids get to the cutting head not only from below, but also from the side through these openings 10a. In this way the solids can get to the blade of the cutting head 7 for comminution and aspiration with liquid through the port.

The cutting head 7 forms in the dirty water flow that is drawn in a whirlpool-like eddy that vibrates is put into vibration by the bump(s) 12, which vibrations guide the solids to the cutting head in surges, thereby significantly improving the cutting performance. As a result of the eddy, the solids move, particularly slide along on the edge 11 of the shield wall, and perform an up and down movement in doing so, thereby causing them to be cut up even more reliably, without clogging the cutting mechanism and the intake openings.

We claim:

1. A grinder pump comprising:
a housing having a bottom wall formed with an intake port;
a drive shaft rotatable in the housing about an axis and projecting axially through the bottom wall;
a pump in the housing having a rotor connected to the shaft and operable to draw liquids and comminuted solids in through the port;
a cutter head outside the housing at the bottom wall and carrying a blade juxtaposed with the bottom wall, the cutter head being fixed on and rotatable with the shaft for comminuting solids drawn into the intake port; and
an annular shield wall projecting axially from the bottom wall around the cutter head and formed with at least one bump forming at least one axially open valley constituting an intake opening through which liquid and solids can be drawn to the intake port by the pump.

2. The grinder pump defined in claim 1, wherein there are three angularly spaced bumps forming three angularly spaced and axially outwardly open valleys.

3. The grinder pump defined in claim 1, wherein the bumps are of different axial heights.

4. The grinder pump defined in claim 1, wherein the bumps are nonuniformly angularly spaced relative to the axis.

5. The grinder pump defined in claim 1, wherein the shield wall has wave-shaped lower edge, whereby the bumps are rounded and convex axially away from the bottom wall.

6. The grinder pump defined in claim 1, wherein the valleys have a axial height from the bottom wall equal to between 1/20 and 1/2 a height of the valleys from the bottom wall.

7. The grinder pump defined in claim 1, wherein one of the valleys has a trough generally level with a planar lower face of the bottom wall.

8. The grinder pump defined in claim 1, wherein there are two bumps diametrally opposite each other.

9. The grinder pump defined in claim 1, wherein the bumps have a W-shape.

10. The grinder pump defined in claim 1, wherein each bump has an apex formed with a U-shaped cutout.

11. The grinder pump defined in claim 1, wherein the bottom wall is a blade plate formed with the intake port and having at the intake port a sharp edge cooperating with the blade of the head.

12. The grinder pump defined in claim 1, wherein the pump is an eccentric pump having a rotor on the shaft and a stator on the housing both formed with helicoidal ridges.

13. A grinder pump comprising:
a housing extending along a vertical axis and having a bottom wall formed with an axially downwardly open intake port;
a drive shaft rotatable in the housing about the axis and projecting axially through the bottom wall;
a pump in the housing above the bottom wall and having a rotor connected to the shaft and operable to draw liquids and comminuted solids in through the port;
a cutter head outside the housing at the bottom wall and carrying a blade juxtaposed with the bottom wall, the cutter head being fixed on and rotatable with the shaft for comminuting solids as they are drawn into the intake port; and
an annular shield wall projecting axially from the bottom wall around the cutter head and formed with at least three angularly spaced bumps forming axially open valleys constituting radially open intake openings through which liquid and solids can be drawn to the intake port by the pump.
